(19) United States
(12) Patent Application Publication
(10) Pub. No.: US 2014/0066566 A1
(43) Pub. Date: Mar. 6, 2014

(54) POLY(METH)ACRYLATE AS MULTIFUNCTIONAL ADDITIVE IN PLASTICS

(71) Applicants: Holger Kautz, Brasschaat (BE); Harald Braun, Herentals (BE); Reza Ghahary, Darmstadt (DE)

(72) Inventors: Holger Kautz, Brasschaat (BE); Harald Braun, Herentals (BE); Reza Ghahary, Darmstadt (DE)

(73) Assignee: Evonik Oil Additives GmbH, Darmstadt (DE)

(21) Appl. No.: 14/110,482

(22) PCT Filed: Apr. 17, 2012
(86) PCT No.: PCT/EP2012/056994

§ 371 Date: Nov. 21, 2013

(30) Foreign Application Priority Data
May 19, 2011 (DE) 10 2011 076 115.2

(51) Int. Cl. C08L 27/06

(52) U.S. Cl. CPC C08L 27/06
USPC 524/523; 525/227

(57) ABSTRACT

The present invention relates to use of a novel, single-component additive for addition to thermoplastics, in particular polyvinyl chloride (PVC). The resultant reduced friction delays melting of the thermoplastic during extrusion and therefore improves fluidity and lowers the process pressure required. The reduced friction moreover facilitates processing in shaping machinery by reducing adhesion to metal. In order to provide these technical improvements, the present invention provides a novel poly(meth)acrylate-based additive for thermoplastics, in particular for PVC. This features a poly(meth)acrylate backbone and long alkyl solid chains.

### FIELD OF THE INVENTION

Many thermoplastics, in particular polyvinyl chloride (PVC), have non-ideal mechanical properties and require additives. Impact modifiers are often added to PMMA or PVC to improve impact resistance. Another factor is the friction exerted by a plastic. Here, many thermoplastics require improved additives which give easier extrudability or proccessability and better mechanical properties. An example of the result of reduced fraction is delayed melting of a thermoplastic during extrusion and therefore improved fluidity and lowering of the process pressure required. Reduced friction moreover facilitates processing in shaping machinery by reducing adhesion to metal. This is particularly true for PVC, which is per se brittle and difficult to extrude because of low melt viscosity.

In order to provide these technical improvements, the present invention provides a novel, single-component poly(meth)acrylate-based additive for thermoplastics, in particular for PVC. This features a poly(meth)acrylate backbone and long alkyl solid chains.

### PRIOR ART

EP 0 132 317 discloses a (meth)acrylate copolymer made of MMA, of an alkyl acrylate having C₁-C₄ moieties and of alkyl acrylates having C₁-C₈ moieties. Although the said polymers reduce friction, there is hardly any advantageous effect on processing on metallic surfaces, because of the high acrylate content.

EP 0 779 336 discloses a lubricant for thermoplastic resins which is composed of two polymers A (at least 50% by weight) and B (at least 0.1% by weight). Polymer A here is composed of at least 50% by weight, but generally 100% by weight of (meth)acrylate monomers having a C₁₂-C₂₄ moiety. Polymer B is composed exclusively of C₁-C₄-(meth)acrylates and its glass transition temperature of at least 15° C. A disadvantage of the said lubricant is that it can only be used in the form of a two-component system, and polymer A tends to block. It is moreover very difficult to ensure that both components of the lubricant have sufficient compatibility with the matrix of the thermoplastic and that there is no microphase separation which adversely affects mechanical properties. This type of incompatibility can also occur when the thermoplastic also comprises additives, e.g. flame retardants, or has high filler content, e.g. of mineral fillers, or has fibre-reinforcement, e.g. by glass fibres or carbon fibres.

### OBJECT

It was an object of the present invention to provide an additive, in particular a lubricant for thermoplastics, in particular for PVC, which has good compatibility with the thermoplastic and also with the additives or additional substances conventional in plastics processing, for example glass fibres, carbon fibres, mineral fillers or flame retardants, and which can be added as one component to the thermoplastic.

Another object was to prove an additive which, during the processing of the thermoplastic, exhibits lower energy consumption requirement and/or lower cycle times, and in particular which can lower processing temperatures, e.g. the mould temperature in the injection-moulding process. At the same time, an intention is to lower melt pressure and/or melt temperature in the extrusion process.

In particular the object of the present invention was that the additives are intended to have high effectiveness. The flowability of the plastics melt concerned is therefore intended to be markedly increased even when the amount added is small.

Another object was that addition of the additive should not impair, or indeed should improve, the mechanical properties, e.g. (notched) impact resistance, of the thermoplastic in comparison with conventional thermoplastics produced without additives or with additives of the prior art. At the same time, the intention is to ensure that the highly flowable moulding compositions have high heat resistance.

A further intention is that the thermoplastic have good weathering resistance, high UV resistance, good resistance to solvents and to other chemicals, and also high surface quality and/or increased surface gloss, even when filler content is high.

### ACHIEVEMENT OF OBJECT

The objects were achieved by providing a novel additive, in particular a novel lubricant for thermoplastics, which is present at a concentration of from 0.01% by weight to 20% by weight, preferably from 0.05% by weight to 15% by weight, in a thermoplastic. The said additive for addition to the thermoplastics involves a poly(meth)acrylate. Constituents of the said poly(meth)acrylate comprise from 10 to 100% by weight of at least one (meth)acrylate having alkyl moieties which are composed of from 9 to 40 carbon atoms, preferably from 9 to 30 carbon atoms.

The said poly(meth)acrylate features in particular, in a first preferred embodiment, a constitution which comprises the following constituents:
a) from 10 to 90% by weight of at least one (meth)acrylate having alkyl moieties which are composed of from 8 to 40 carbon atoms, and
b) from 10 to 50%, preferably from 15 to 40% by weight, of at least one α-olefin having alkyl moieties which are composed of from 4 to 14 carbon atoms.

The (meth)acrylates a) here which comprise alkyl moieties which are composed of from 8 to 40 carbon atoms are preferably composed of a1) from 10 to 60% by weight, preferably from 20 to 50% by weight, of at least one (meth)acrylate having alkyl moieties which are composed of from 8 to 12 carbon atoms, and a2) from 10 to 60% by weight, preferably from 30 to 50% by weight, of at least one (meth)acrylate having alkyl moieties which are composed of from 12 to 40, preferably from 12 to 30, carbon atoms. Both of the monomers a1) and a2) here can respectively be composed of just one species or of any mixture of different species, composed of acrylates and/or of methacrylates, which in turn have various moieties having the numbers of carbon atoms stated above.

The wording “from 8 to 12 carbon atoms” here describes a carbon moiety which is derivable from a corresponding alcohol which then in turn has been esterified with (meth)acrylic acid. The moieties can be linear, branched or indeed to some extent cyclic moieties. The numeric value must not necessarily involve an integer. In the case of a mixture of repeating units having various moieties having from 8 to 12 carbon atoms, a corresponding average value is calculated. The limits for the said average value are correspondingly 8.0 and 12.0.

Analogous considerations apply to the repeating units a2) having alkyl moieties which comprise from 12 to 40 carbon atoms. The limiting values for the average value for the repeating units a2) are correspondingly 12.0 as lower limit and 40.0 as upper limit. Repeating units having precisely 12 carbon atoms, e.g. dodecyl(meth)acrylate, can be a constituent a1) and also a2) of the constitution here.

In a second preferred embodiment, a feature of the additive is that the additive involves a poly(meth)acrylate and that the said poly(meth)acrylate comprises from 10 to 100% by weight of at least one repeating unit formed from (meth)acrylates a3) having alkyl moieties which are composed of from 9 to 20, preferably from 10 to 16, carbon atoms, where from 10 to 80% by weight, preferably from 20 to 65% by weight, of the alkyl moieties are branched moieties. An alkyl moiety is considered to be a branched moiety when it comprises at least one tertiary carbon atom.

In one particularly preferred embodiment, the material here involves a poly(meth)acrylate which comprises 100% by weight of the branched repeating units a3), and which has a molecular weight of from 5000 to 15 000.

The lubricant can comprise, in addition to the repeating units a) and b) of the first embodiment and/or the to some extent branched repeating units a) of the second embodiment, up to 20.0% by weight, preferably from 0.1 to 20.0% by weight, particularly preferably from 1 to 15% by weight, of one or more acrylates (c) which comprise an alkyl moiety composed of from 1 to 7 carbon atoms. Examples illustrating repeating units c) are ethyl, propyl and butyl acrylate.

The additive can moreover comprise up to 20.0% by weight, preferably from 0.1 to 20.0% by weight, particularly preferably from 1 to 15% by weight, of one or more methacrylates d) which comprise an alkyl moiety composed of from 1 to 7 carbon atoms. Examples illustrating repeating units d) are hexyl methacrylate and heptyl methacrylate.

The glass transition temperature of a theoretical homopolymer composed of the said (meth)acrylates c) and/or d) would be below 0° C. The glass transition temperature of each individual homopolymer composed of one of the said (meth)acrylates would preferably be below 0° C.

The term “(meth)acrylate” used in the context of this specification means the esters of (meth)acrylic acid, its meaning here being either methacrylate, e.g. methyl methacrylate, ethyl methacrylate, etc., or acrylate, e.g. methyl acrylate, ethyl acrylate etc., or a mixture of the two.

The repeating units a1) having alkyl moieties composed of from 8 to 12 carbon atoms are obtained through copolymerization of corresponding monomers. Examples of these monomers a1) are 2-ethylhexyl(meth)acrylate, 2-tert-butylheptyl(meth)acrylate, octyl(meth)acrylate, 3-isopropylheptyl(meth)acrylate, nonyl(meth)acrylate, decyl(meth)acrylate, undecyl(meth)acrylate, 5-methylundecyl(meth)acrylate and dodecyl(meth)acrylate.

Examples of monomers illustrating repeating units a2) having alkyl moieties composed of from 12 to 40 carbon atoms are not only dodecyl(meth)acrylate but especially monomers which are obtained by reacting (meth)acrylates with long-chain fatty alcohols. The fatty alcohols here generally involve mixtures of various long-chain alcohols. Among the said fatty alcohols are inter alia Oxo Alcohol® 7911, Oxo Alcohol® 7900, Oxo Alcohol® 1100; Alfol® 610, Alfol® 810, Lial® 125 and Nafol® products (Sasol); C13-C15-Alkohol (BASF); (Afton); Linevol® 79, Linevol® 911 and Neodol® 25 (Shell); Dehydad®, Hydrenol® and Lorol® products (Cognis); Exxal® 10 (Exxon Chemicals), ECOROL® 8/98, ECOROL® 12/98, ECOROL® 14/98 and ECOROL® 16/98 (Ecogreen Oleochemicals); PALMEROL® 0898 NF, PALMEROL® 1098 NF, PALMEROL® 0810 NF, PALMEROL® 1299 NF and PALMEROL® 1499 NF (KLK OLEO); Vegarol® 8, Vegarol® 10, Vegarol® 12 and Vegarol® 14 (Berg+Schmidt); Mascol® 24; Isofol® 24, Isofol® 28, Isofol® 32 (Sasol) and Kalcol® 2465 (Kao Chemicals). The said alcohols, the (meth)acrylates produced therefrom and the polymers obtained therefrom are generally and preferably liquid. In particular the liquid form of the polyfunctional additives has great advantages in the compounding process and in effectiveness in the thermoplastic matrix.

The branched repeating units a3) involve (meth)acrylates having alkyl moieties composed of from 9 to 40 carbon atom, where from 10 to 80% by weight of the alkyl moieties are branched moieties. “Branched” means in this context that the moiety comprises at least one tertiary carbon atom. The branching groups generally involve C₁-C₁₄ moieties, in particular methyl, ethyl or propyl branches. However, longer branching groups and/or mixtures of various branches are also advantageous. The location of the branching, starting from the ester group, is generally at the second to fifth carbon atom of the moiety.

The α-olefins having 4 to 14 carbon atoms can involve by way of example 1-butene, 1-pentene, 1-heptene, 1-octene, 1-decene, 1-dodecene or ethylhex-1-ene. Particular preference is given to 1-decene or 1-dodecene.

The additive preferably involves a poly(meth)acrylate with a glass transition temperature from −100 to 0° C., preferably from −90 to −40° C. and particularly preferably from −80 to −60° C. The glass transition temperatures T_{g} are determined here for the purposes of this invention in accordance with DIN EN ISO 11357-1.

The average molecular weight (M_{w}) of the additive according to the invention is moreover preferably from 5000 to 75 000, preferably from 5000 to 50 000 and particularly preferably from 8000 to 40 000. The molecular weights here are determined for the purposes of this invention by means of gel permeation chromatography in accordance with DIN EN ISO 11357-1.

The additive according to the invention can preferably involve a lubricant, as used for example in the automotive sector. The kinematic viscosity KV100 of the lubricant is preferably at least 30 mm²/s, preferably from 30 to 700 mm²/s, particularly preferably from 200 to 600 mm²/s. This is measured in accordance with ASTM D 445 at 100° C.

The polydispersity of the additives is from 1.1 to 4.0. The additives can be produced not only by the traditional free-radical polymerization process but also by means of living and/or controlled free-radical polymerization techniques, such as NMP (Nitroxide Mediated Polymerization), RAFT (Reversible Addition Fragmentation Chain Transfer polymerization) or ATRP (Atom Transfer Radical Polymerization). In this case the polydispersity of the additives according to the invention is from 1.1 to 2.5, preferably from 1.5 to 1.8.

The preferred free-radical polymerization process can be initiated by peroxides known to the person skilled in the art, e.g. dilauroyl peroxide or dibenzoyl peroxide, or by azo initiators, such as 2,2′-azobisisobutyronitrile. It is also possible here to use mixtures of various initiators. The initiation process can also take place in a plurality of steps and/or through feeding of the initiator. A detailed description of the production of similar polymers is found by way of example in the German Patent Application DE 10 2010 028 195.6, and can also be applied to the production of the additives according to the invention.

The polymerization process can be carried out with or without chain transfer agents, such as mercaptans. In the case of additives of the first preferred embodiment it is preferable not to use chain transfer agents. In the case of additives of the second preferred embodiment, in contrast, from 1.0 to 7.0% by weight, preferably from 2.0 to 4.5% by weight, of a chain transfer agent is used.

The thermoplastic to which an additive according to the invention is added can involve any known industrial thermoplastic, for example PE, HDPE, LLDPE, UMWHDPE, PP, an APAO, an EPDM, an EPM, PPSU, ABS, a polyamide, PTFE, PS, PC, PEEK, PET, PPT or PMMA. In particular, the thermoplastic involves polyvinyl chloride.

It is moreover possible that the additive, for example for use as lubricant, has undergone further preformulation prior to addition to the thermoplastic. To this end, the additive can also comprise by way of example from 0.1 to 10% by weight of polymerization auxiliaries and/or of additives. The additive can moreover have undergone preformulation in a masterbatch together with impact modifiers, pigments, colorants, stabilizers, e.g. UV stabilizers or antioxidants, adhesion promoters, compatibilizers or plasticizers.

In one particular embodiment, the additive—optionally together with other components—is mixed with a portion of the thermoplastic in the form of masterbatch and then processed with the thermoplastic. Since the additive is per se liquid, this type of solid masterbatch has great advantages for subsequent metering, e.g. into an extruder, in comparison with direct addition of the additive.

The thermoplastic can moreover comprise fillers, carbon fibres, glass fibres and/or other additives. These thermoplastics can generally comprise a total of up to 60% by weight of fillers, carbon fibres, glass fibres and/or other additives.

An extruder is generally used for the addition of the additive to the thermoplastic. The processing of the formulation in the extruder here can be combined with other operations, such as mixing with other thermoplastics, and other additive addition processes, through to the shaping process at the end of the extrusion process.

Surprisingly, thermoplastics comprising the additives according to the invention have many advantages over the prior art:
The additives can be produced easily and at low cost.
Relatively low temperatures can be used for extrusion or subsequent injection moulding of the thermoplastics comprising additives according to the invention.
The additives exhibit high compatibility with a wide variety of thermoplastics.
In particular, the additives exhibit high compatibility with PVC. Foils comprising these additives can, for example, therefore be calendered more successfully.
The notched impact resistance of the PVC is at least comparable with that of PVC comprising additives according to the prior art.
Heat resistance of a PVC comprising additives is better than in the prior art.
The additive according to the invention has no adverse effect on the weathering resistance, UV resistance and chemicals resistance of the thermoplastics.
Melt viscosity can be markedly reduced even when amounts added are small: below 10% by weight.
The additives exhibit high compatibility with a large number of additional substances, such as glass fibres, carbon fibres and mineral fillers.
The output rate of the extrusion process is markedly increased.
The shaping of the profile geometries of the thermoplastic is improved.
It is possible to achieve a marked reduction in plate-out from the entire formulation. Plate-out involves deposits in the extruder or in the mould, and these cause specks, discoloration and surface defects in the product.
The frequency of necessary cleaning operations can thus be reduced, and stoppage times can therefore be reduced.
The dimensional accuracy in particular of thin fillets was improved, as also therefore was the stability by way of example of window profiles. This makes thin fillets more resistant to breakage and gives profiles with longer lifetime.

The additive can be produced by means of established polymerization methods and/or polymerization techniques. The lubricant is generally produced by continuous, semicontinuous or batchwise bulk polymerization or by solution polymerization. In case of a solution polymerization process, the solvent is removed once synthesis is complete, and can preferably be reused in a subsequent production process.

Additives of the first preferred embodiment are preferably produced by means of bulk polymerization, and those of the second preferred embodiment are preferably produced by means of a solution polymerization process described above.

From 0.05 to 10.0% by weight of the additive according to the invention is generally added to the thermoplastic. The resultant thermoplastic comprising additive is per se also provided by the present invention. The present invention in particular provides thermoplastics which comprise, as single lubricant, the additive described.

### EXAMPLES

Test Methods

GPC was used to determine weight-average molecular weight Mw, and also polydispersity index PDI for the polymers. The measurements were made in THF at 35° C. against a PMMA standard from a set of ≧25 standards (Polymer Standards Service or Polymer Laboratories) of which the Mpeak had uniform logarithmic distribution over the range from 5·10₆ to 2·10₂ g/mol. A combination of six columns was used (Polymer Standards Service SDV 100A/2×SDV LXL/2×SDV 100A/Shodex KF-800D). Signals were recorded by using an RI detector (Agilent 1100 Series).

Colour difference was determined in accordance with DIN 6174 with a Data Color Spectraflash SF 405 with diffuse illumination through a photometer sphere and measurement at 8°. The illuminant used was natural daylight (D65). The results were expressed in the Cie Lab system. The corresponding tables list the b values, which are particularly important for PVC. Other values (L values and a values, and also colour differences) are available, but for simplicity have not been printed out. There are no significant differences in these values between examples according to the invention and comparative examples. The b values of the Lab colour space provide the best indication of the yellow coloration that is particularly relevant for PVC.

The gloss tests were carried out in accordance with DIN 67530 60 degrees, by using a LMG Refo 3 gloss tester. The test was carried out at 10 different points on test specimens with smooth surface. The values listed are averages calculated from the minimum and maximum values determined. No evaluation was carried out in cases where differences between the said two values were greater than 4.0.

Raw Materials Used

Vinnolit S 3268 and Solvin 267 RC respectively involve commercially available PVCs.

Omya 95 T, Precarb 400 and Hydrocarb 95 T respectively involve CaCO₃ fillers.

Tiona RCL 168 and Kronos 2220 respectively involve TiO₂ pigments.

DEGALAN 10 F and DEGALAN 75 F respectively involve commercially available processing aids for PVC.

DEGALAN EST 7 D and Paraloid KM 370 respectively involve commercially available impact modifiers for PVC.

Baeropan TX 9600 FP 4 involves a commercially available Ca/Zn stabilizer for PVC, being a one-pack PVC heat stabilizer also comprising lubricant and processing aid, alongside stabilizing components.

Monomers

Content of linear and branched moieties was determined by means of gas chromatography (GC), and also ¹³C and ¹H NMR.

C₁₂₋₁₅-MA: Alkyl methacrylate which has from 12 to 15 carbon atoms in the alkyl moiety, where the alkyl moiety is a mixture having branched and linear moieties:
content of C₁₂ branched: about 12% by weight and of C₁₂ linear: about 11.3% by weight;
content of C₁₃ branched: about 17.3% by weight and of C₁₃ linear: about 13.5% by weight;
content of C₁₄ branched: about 15.7% by weight and of C₁₄ linear: about 11.9% by weight;
content of C₁₅ branched: about 9.8% by weight and of C₁₅ linear: about 6.2% by weight;
   content of methyl branches about 14%, content of ethyl branches about 10%, content of propyl branches about 10%, content of longer-chain branches about 17%, based on the entirety of linear and branched moieties.

C₉₁₀₃-MA: Alkyl methacrylate which has about 10 carbon atoms in the alkyl moiety, where the alkyl moiety is a mixture having predominantly branched moieties:
content of branched moieties about 98% by weight;
content of C₁₀ about 89.9% by weight;
content of C₁₁ about 4.6% by weight

1-decene

Precursors 1-3 (PC1-3)

The polymers used as additive in the inventive examples were produced in accordance with the general production specification.

1-Decene was used as initial charge in a round 1 litre 4-necked flask equipped with a stirrer with precision glass gland (150 revolutions per minute), thermometer and reflux condenser (total amount of all monomers: 760.0 g; see Table 1 for precise constitution of monomer mixture), and was heated to 140° C. Feeding of the remaining monomers and of the initiator was then started. 4.94 g of tert-butyl 2-ethylperhexanoate (dissolved in 22 g of Nexbase 3020) were fed continuously as initiator within the period of 11 hours. The continuous feed of the remaining monomers was started simultaneously and proceeded over a period of 7 hours (PC3: 5 h). Total reaction time was 12 hours. Finally, volatile constituents were removed in vacuo at a temperature of 170° C.

TABLE 1

| Inventive | C₁₂₋₁₅-MA | C_{9-10,3}-MA | 1-Decene | M_{w} |
|---|---|---|---|---|
| example | [% by wt.] | [% by wt.] | [% by wt.] | [g/mol] |
| PC1 | 38.8 | 31.6 | 29.6 | 10 000 |
| PC2 | 43.0 | 35.0 | 22.0 | 15 000 |
| PC3 | 43.0 | 35.0 | 22.0 | 20 000 |

### Inventive Examples 1-6 (IE1-6) and Comparative Example 1 (CE1)

IE1-6 and CE1 were carried out in a Krauss Maffei KMDL 25 twin-screw extruder with screw rotation rate 30 rpm, metering screw rotation rate 20 rpm, preconditioning temperature 170° C., inlet temperature 190° C. and constant die temperature (2 measurement points) of 195° C. Barrel temperatures set were 185° C. in the frontal region and 190° C. in the rear region. The fill level used was 100%.

Table 2 shows the respective constitutions. Table 3 shows the related experimental results and variable extruder parameters. Melt pressures 1 to 3 were measured, with melt temperature, directly after feed (1), in the middle of the extruder (2) and shortly prior to take-off (3).

TABLE 2

| | IE1 | IE2 | IE3 | IE4 | IE5 | IE6 | CE1 |
|---|---|---|---|---|---|---|---|
| Vinolit S 3268 | 6000 g | | | | | | |
| Omya 95 T | 300 g | | | | | | |
| Tiona RCL 168 | 240 g | | | | | | |
| DEGALAN | 60 g | | | | | | |
| 10 F | | | | | | | |
| DEGALAN | 360 g | | | | | | |
| EST 7 D | | | | | | | |
| Beropan TX | 204 g | | | | | | |
| 9600 FP 4 | | | | | | | |
| Precursor 1 | 6.0 g | — | — | 18.0 g | — | — | — |
| Precursor 2 | — | 6.0 g | — | — | 18.0 g | — | — |
| Precursor 3 | — | — | 6.0 g | — | — | 18.0 g | — |

TABLE 3

| | IE1 | IE2 | IE3 | IE4 | IE5 | IE6 | CE1 |
|---|---|---|---|---|---|---|---|
| Torque | 41% | 39% | 38% | 36% | 34% | 34% | 45% |
| Melt pressure 1 [bar] | 21 | 20 | 20 | 15 | 13 | 14 | 25 |
| Melt pressure 2 [bar] | 34 | 37 | 37 | 35 | 35 | 36 | 36 |
| Melt pressure 3 [bar] | 145 | 143 | 142 | 134 | 135 | 137 | 147 |
| Melt temperature [° C.] | 194 | 194 | 194 | 193 | 193 | 193 | 194 |
| Specific energy | 0.106 | 0.104 | 0.104 | 0.098 | 0.092 | 0.092 | 0.113 |
| [kW/kg] | | | | | | | |
| b values | 8.62 | 8.04 | 5.33 | 6.47 | 5.98 | 5.99 | 9.05 |
| Gloss (upper side) | 48.5 | 46.0 | 47.2 | 67.1 | 60.6 | 59.4 | 47.5 |
| Gloss (lower side) | 37.9 | 41.2 | 39.1 | 56.0 | 44.1 | 53.4 | 39.6 |

From Inventive Examples 1-3 with only small concentration of the additive according to the invention, 0.08% by weight, it is already possible to see that the amount of energy required during the extrusion process is smaller, and that melt pressure can be noticeably reduced during the extrusion process. There is also already an improvement in the yellowness values in comparison with the prior art. These results can be further improved when the concentration of the additive is higher, about 0.25% by weight (Inventive Examples 4-6). This is particularly true for the yellowness values and the melt pressure in the ingoing region of the extruder. The gloss values can also be improved here, the overall effect therefore being to produce a PVC with higher surface quality and improved appearance.

### Inventive Examples 7-8 (IE7-8) and Comparative Examples 2 and 3 (CE2-3)

IE7-8 and CE2-3 used a Weber 11-25 contrarotating twin-screw extruder with die attached for moulding window profiles (Greiner). The screw rotation rate was set to 40 rpm here. The fill level used was 100%.

The temperature profile has 5 heating zones, with temperature rising from 160° C. at the feed to 190° C. at the die, with a mould temperature of 190° C.

Table 4 shows the respective constitutions. Table 5 shows the related experimental results and variable extruder parameters. Melt pressures 1 to 3 were measured after a distance within the extruder corresponding to 9 times (1), 14 times (2) and 20 times (3) the diameter of the extruder (D9, D14 and D20). Melt pressure 4 corresponds to the pressure shortly prior to the die and melt pressure 5 corresponds to the pressure shortly after the die.

TABLE 4

| | IE7 | IE8 | IE9 | IE10 | IE11 | IE12 | CE2 |
|---|---|---|---|---|---|---|---|
| Solvin 267 RC | 9450 g | | | | | | |
| Paraloid KM 370 | 550 g | | | | | | |
| Precarb 400 | 700 g | | | | | | |
| Hydrocarb 95 T | 300 g | | | | | | |
| Kronos 2220 | 330 g | | | | | | |
| CaZn stabilizer | 367 g | | | | | | |
| Precursor 1 | 15.0 g | 30.0 g | — | — | — | — | — |
| Precursor 2 | — | — | 15.0 g | 30.0 g | — | — | — |
| Precursor 3 | — | — | — | — | 15.0 g | 30.0 g | — |

TABLE 5

| | IE7 | IE8 | IE9 | IE10 | IE11 | IE12 | CE2 |
|---|---|---|---|---|---|---|---|
| Melt pressure 1 [bar] | 155 | 142 | 171 | 156 | 178 | 156 | 172 |
| Melt pressure 2 [bar] | 254 | 221 | 274 | 240 | 285 | 246 | 302 |
| Melt pressure 3 [bar] | 445 | 373 | 463 | 386 | 463 | 392 | 503 |
| Melt pressure 4 [bar] | 277 | 233 | 286 | 241 | 287 | 245 | 310 |
| Melt pressure 5 [bar] | 101 | 86 | 104 | 89 | 105 | 91 | 112 |
| Output [kg/h] | 1.30 | 1.39 | 1.32 | 1.43 | 1.33 | 1.45 | 1.10 |
| Motor load [Nm] | 50.68 | 44.24 | 52.05 | 45.70 | 52.54 | 46.19 | 58.01 |
| b value | 5.48 | 4.93 | 5.42 | 4.75 | 5.34 | 4.76 | 6.35 |

When these experiments are carried out with a single-screw extruder, the extrusion process also takes place at relatively low pressures and/or relatively small motor load. Here again, products with relatively little yellow coloration are obtained. It is also possible to raise the yields in comparison with CE2 without additive by up to more than 20%.

1-19. (canceled)

20. A thermoplastic comprising from 0.05% by weight to 20% by weight of an additive comprising a poly(meth)acrylate, wherein the poly(meth)acrylate comprises from 10 to 100% by weight of at least one (meth)acrylate having alkyl moieties comprising from 9 to 40 carbon atoms.

21. The thermoplastic according to claim 20, wherein the poly(meth)acrylate comprises:
from 10 to 90% by weight of at least one (meth)acrylate having alkyl moieties comprising from 9 to 40 carbon atoms; and
from 10 to 50% by weight of at least one α-olefin having alkyl moieties comprising from 4 to 14 carbon atoms.

22. The thermoplastic according to claim 21, wherein the poly(meth)acrylate comprises:
from 10 to 60% by weight of at least one (meth)acrylate having alkyl moieties comprising from 9 to 12 carbon atoms;
from 10 to 60% by weight of at least one (meth)acrylate having alkyl moieties comprising from 12 to 40 carbon atoms, such that all of (meth)acrylate monomers having alkyl moieties comprising from 8 to 40 carbon atoms amount to at most 90% by weight; and
from 10 to 50% by weight of at least one α-olefin having alkyl moieties comprising from 4 to 14 carbon atoms.

23. The thermoplastic according to claim 20, wherein the additive comprises a poly(meth)acrylate comprising from 10 to 100% by weight of at least one (meth)acrylate having alkyl moieties comprising from 9 to 20 carbon atoms, such that from 10 to 80% by weight of the alkyl moieties are branched moieties.

24. The thermoplastic according to claim 23, wherein the poly(meth)acrylate consists of at least one (meth)acrylate having alkyl moieties comprising from 10 to 16 carbon atoms, such that:
from 10 to 80% by weight of the alkyl moieties are branched moieties; and
the molecular weight of the poly(meth)acrylate is from 5000 to 15 000.

25. The thermoplastic of claim 20, wherein the additive comprises a poly(meth)acrylate with a glass transition temperature from −100 to 0° C., said poly(meth)acrylate comprising:
from 20 to 50% by weight of at least one (meth)acrylate having alkyl moieties comprising from 8 to 12 carbon atoms;
from 30 to 50% by weight of at least one (meth)acrylate having alkyl moieties comprising from 12 to 40 carbon atoms; and
from 15 to 40% by weight of at least one α-olefin having alkyl moieties comprising from 4 to 14 carbon atoms.

26. The thermoplastic of claim 20, wherein an average molecular weight (M_{w}) of the additive is from 5000 to 75 000.

27. The thermoplastic according to claim 26, wherein an average molecular weight (M_{W}) of the additive is from 8000 to 40 000.

28. The thermoplastic of claim 20, wherein the additive further comprises a lubricant having a kinematic viscosity KV100 of at least 30 mm²/s, measured at 100° C. in accordance with ASTM D 445.

29. The thermoplastic of claim 20, wherein the additive further comprises:
from 0.1 to 20.0% by weight of at least one acrylate having an alkyl moiety comprising from 1 to 7 carbon atoms, said alkyl moiety having, as homopolymer, a glass transition temperature below 0° C.; and/or
from 0.1 to 20.0% by weight of at least one methacrylate having an alkyl moiety comprising from 1 to 7 carbon atoms.

30. The thermoplastic of claim 20, further comprising a polyvinyl chloride.

31. The thermoplastic of claim 20, wherein the additive further comprises from 0.1 to 10% by weight of a polymerization auxiliary and/or an additional additive.

32. The thermoplastic of claim 20, comprising from 0.05 to 10% by weight of the additive.

33. The thermoplastic of claim 32, consisting of the additive.

34. The thermoplastic of claim 32, wherein further comprising up to 60% by weight of at least one selected from the group consisting of a filler, a carbon fiber, a glass fiber and an additional additive.

35. A process, comprising mixing t from 0.05 to 10% by weight of an additive with a polymer in an extruder to form the thermoplastic of claim 20.

36. The process according to claim 35, wherein the additive is introduced in the form of a masterbatch into the extruder.
